(19) United States
(12) Patent Application Publication
(10) Pub. No.: US 2012/0246090 A1
(43) Pub. Date: Sep. 27, 2012

(54) Courier Management

(75) Inventors: Charles M. Griffith, Bainbridge Island, WA (US); Jinqian Li, Bellevue, WA (US); Jonathan J. Shakes, Mercer Island, WA (US); Jin Lai, Beijing (CN)

(73) Assignee: AMAZON TECHNOLOGIES, INC., Reno, NV (US)

(21) Appl. No.: 13/052,589

(22) Filed: Mar. 21, 2011

(51) Int. Cl. G06Q 30/00

(52) U.S. Cl. 705/330

(57) ABSTRACT

The present disclosure relates to the generation of shipping labels that aid in delivery of shipments. In one example, at least a portion of a carrier infrastructure is identified that is to be used to deliver each one of a plurality of shipments, where each of the shipments corresponds to one of a plurality of destination locations. A shipping label is generated for each of the shipments. Each shipping label expresses both a respective one of the destination locations and a recitation of the portion of the carrier infrastructure employed to deliver a corresponding one of the shipments to a respective one of the destination locations.

### BACKGROUND

In some regions, a shipping address is not a reliable indicator of the actual location of a residence or office of a customer. For example, zip codes or other portions of shipping addresses may be incorrect, or postal delivery systems may be underdeveloped. As a consequence, shipments to addresses can be delayed due to the time needed for the courier to find the correct location of the residence or office. Also, shipments may become lost which results in concessions to customers and a poor customer experience.

### BRIEF DESCRIPTION OF THE DRAWINGS

Many aspects of the present disclosure can be better understood with reference to the following drawings. The components in the drawings are not necessarily to scale, emphasis instead being placed upon clearly illustrating the principles of the disclosure. Moreover, in the drawings, like reference numerals designate corresponding parts throughout the several views.

FIG. 1 is a drawing of networked environment according to various embodiments of the present disclosure.

FIG. 2 is a drawing of an example of a carrier infrastructure associated with a carrier according to various embodiments of the present disclosure.

FIG. 3 is a drawing of an example of a shipping label according to various embodiments of the present disclosure.

FIGS. 4A and 4B are flowcharts illustrating examples of functionality implemented as portions of courier management application executed in a computing device in the networked environment of FIG. 1 according to various embodiments of the present disclosure.

FIG. 5 is a schematic block diagram that provides one example illustration of a computing device employed in the networked environment of FIG. 1 according to various embodiments of the present disclosure.

### DETAILED DESCRIPTION

The present application describes various embodiments of systems and methods for courier management. For example, in some embodiments, a computing device generates geocode locations (e.g., a latitude and a longitude) based at least in part on customer locations. The computing device determines the portion of a carrier infrastructure in terms of carrier resources that are invoked to effect the delivery of a package that includes an item given the address or geocode of a customer who is to receive a shipment. Ultimately, the resources that make up the portion of the carrier infrastructure are printed on a shipping label with the customer address/geocode to help guide the carrier in shipping a package including one or more items. Such information is particularly useful in regions where shipping addresses or zip codes are sometimes unreliable, and/or where carrier operations may be less than optimal. In the following discussion, a general description of the system and its components is provided, followed by a discussion of the operation of the same.

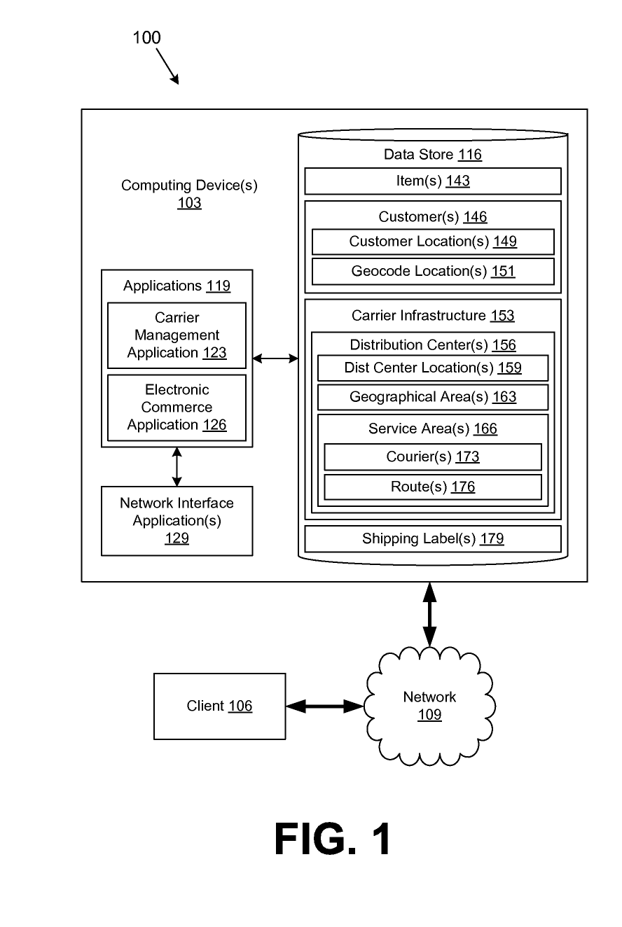

With reference to FIG. 1, shown is a networked environment 100 according to various embodiments. The networked environment 100 includes a computing device 103, a client 106, and a network 109. The network 109 includes, for example, the Internet, intranets, extranets, wide area networks (WANs), local area networks (LANs), wired networks, wireless networks, or other suitable networks, etc., or any combination of two or more such networks.

The computing device 103 may comprise, for example, a server computer or any other system providing computing capability. Alternatively, a plurality of computing devices 103 may be employed that are arranged, for example, in one or more server banks or computer banks or other arrangements. For example, a plurality of computing devices 103 together may comprise a networked computing resource, a grid computing resource, and/or any other distributed computing arrangement. Such computing devices 103 may be located in a single installation or may be distributed among many different geographical locations. For purposes of convenience, the computing device 103 is referred to herein in the singular. Even though the computing device 103 is referred to in the singular, it is understood that a plurality of computing devices 103 may be employed in the various arrangements as described above.

Various applications and/or other functionality may be executed in the computing device 103 according to various embodiments. Also, various data is stored in a data store 116 that is accessible to the computing device 103. The data store 116 may be representative of a plurality of data stores as can be appreciated. The data stored in the data store 116, for example, is associated with the operation of the various applications and/or functional entities described below.

The components executed on the computing device 103, for example, include applications 119 such as a carrier management application 123 and, in some embodiments, an electronic commerce application 126. The components executed on the computing device 103 may further include a network interface application(s) 129 as well as other applications, services, processes, systems, engines, or functionality not discussed in detail herein. The network interface application 129 may comprise, for example, a front end web server or other networking application.

The electronic commerce application 126 is executed in order to facilitate the online purchase of items 143 over the network 109. The electronic commerce application 126 also performs various backend functions associated with the online presence of a merchant in order to facilitate the online purchase of items 143. For example, the electronic commerce application 126 generates network pages such as web pages or other types of network content that are provided to clients 106 for the purposes of selecting items for purchase, rental, download, lease, or other form of consumption. It should be noted that the electronic commerce application 126 and the carrier management application 123 are operated by or on the behalf of a merchant that sells items 143 through the network.

The data stored in the data store 116 includes, for example, items 143. As used herein, the term “item” 143 may refer to a product, good, or other item 143 that may be offered for sale, purchase, rental, lease, and/or another form of consumption as may be appreciated. Ultimately, one or more items 143 may be included in a package that is delivered to a customer. The items 143 may be stored in a catalog for purchase through the electronic commerce application 126 as can be appreciated. Also, the data store 116 stores information associated with customers 146 such as customer location(s) 149, geocode location(s) 151, and other information related to customers 146. Such other information may include, purchase histories, payment instrument information, browse histories, billing addresses, product preferences, personal profile information, and other information. The customer locations 149 may comprise, for example, a customer address or other location information. A geocode location 151 is a location that may be expressed in various forms. In one embodiment, a geocode location 151 may be expressed as a latitudinal value and a longitudinal value. Also, a geocode location 151 may be expressed in terms of an elevation in situations where customers live in units, for example in a high rise building. Also, various information may be associated with a geocode location 151 such as the name and age of an occupant, or other information. In some cases, a geocode location 151 may be based at least in part on a customer location 149.

The customer location 149 is associated with a customer explicitly or implicitly from a client 106. As an example of an explicit association, in some embodiments, the customer location 149 is a shipping address provided by a customer 146. Specifically, the customer location 149 may be obtained from a customer input on a network page such as entry of an address, clicking on a specific point on a graphical map, or some other action that explicitly provides the geographic location. The entered customer location 149 is associated with the customer 146 in the data store 116.

The customer location 149 may be provided implicitly as well using information such as an internet protocol (IP) address, a telephone number, and/or other information. Further, the client 106 may include a global positioning system (GPS) device or may determine a current location of the customer by way of trilateration using various other mobile base stations having known locations. Alternatively, in some embodiments, a customer location 149 may be stored on the computing device 103 because the customer 146 may have previously registered with the electronic commerce application 126. As such, an identification of the customer, for example, through cookies, security credentials, etc., may point to a customer location 149 corresponding to a customer 146.

The data store 116 further stores information related to carriers that ship packages containing items 143 sold by a merchant to customers 146. The carrier will have a carrier infrastructure 153 to accomplish the delivery of packages containing items 143 to customers 146. In one approach, the carrier may be a separate entity from the merchant or the merchant may act as their own carrier.

The carrier infrastructure 153 may include one or more materials handling facilities 156. A materials handling facility 156 may comprise, for example, a warehouse, distribution center, cross-docking facility, order fulfillment center (also referred to as a fulfillment facility), packaging facility, shipping facility, brick-and-mortar stores, retail outlets, or other facility or combination of facilities for performing one or more functions of material or inventory handling.

The materials handling facilities 156 are located at various materials handling facility locations 159. According to one embodiment, each materials handling facility 156 services a geographical area 163. Each geographical area 163 may include one or more service areas 166 that may be serviced by one or more couriers 173. In addition, couriers 173 may be assigned specific delivery routes 176 to follow. In one embodiment, such routes 176 are determined just before deliveries are to be made. Alternatively, it may be the case that some couriers 173 are assigned the same route 176 each day. According to various embodiments, one or more portions of the carrier infrastructure 153 are identified and placed on a shipping label 179 to assist the carrier in delivering packages containing items 143 as will be described.

The couriers 173 ultimately perform various courier task(s) in a service area 166 or along a route 176. A courier task may include a delivery of a package to a customer 146, a pick-up of at least one item 143, or other types of tasks.

In addition, the activity of a courier 173 causes the generation of courier events that may comprise, for example, the successful delivery of a package containing one or more items 143 to a customer 146, the successful pickup of at least one item 143 from a customer 146, an arrival or departure of a package containing one or more items 143 to or from a service area 166, materials handling facility 156, or geographical area 163, a failure to deliver or pick-up an item 143 at a customer location 149, and other events related to the activity of a courier 173. In some embodiments, a courier event 164 is associated with a customer location 149.

The client 106 is coupled to the network 109. The client 106 may comprise, for example, a processor-based system such as computer system. Such a computer system may be embodied in the form of a desktop computer, a laptop computer, a personal digital assistant, a cellular telephone, a set-top box, a music player, a web pad, a tablet computer system, or other devices with like capability. To this end, the client 106 may comprise a mobile computing device as can be appreciated. Additionally, the client 106 may include, for example, a keyboard, a keypad, a touch pad, a touch screen, a microphone, a scanner, a mouse, a joystick, or one or more push buttons, etc. The client 106 may also include display devices, indicator lights, speakers, etc. Examples of display devices are cathode ray tubes (CRTs), liquid crystal display (LCD) screens, gas plasma-based flat panel displays, LCD projectors, or other types of display devices, etc. A client 106 may be configured to execute various applications such as a browser, email applications, instant message applications, and/or other applications.

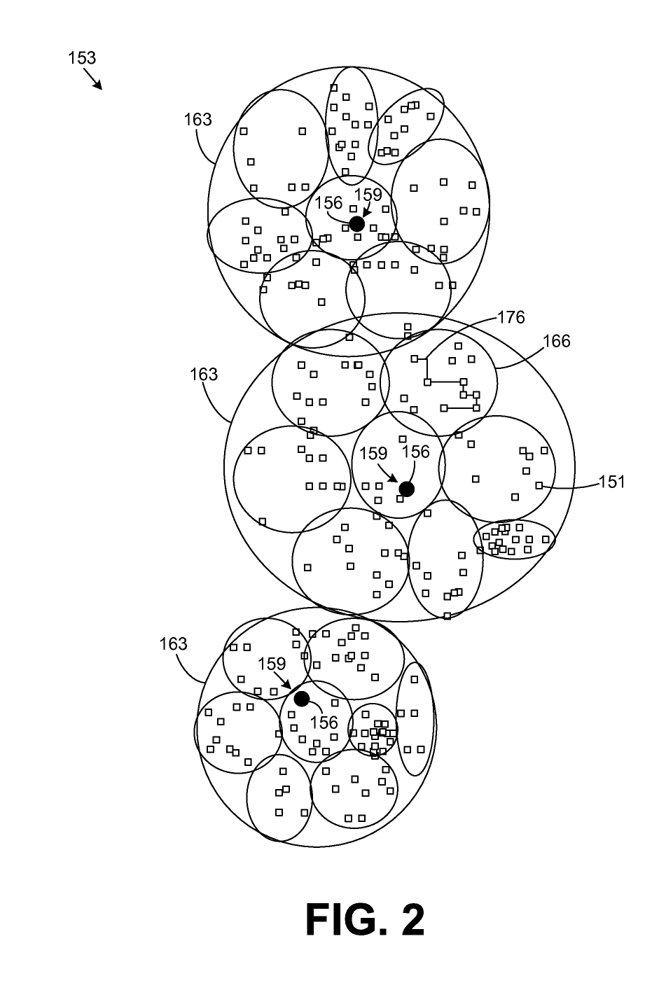

Moving now to FIG. 2, shown is a drawing of an example of a carrier infrastructure 153 according to various embodiments of the present disclosure. The carrier infrastructure 153 shown in FIG. 2 includes examples of geographical areas 163 associated with respective materials handling facilities 156. Each materials handling facility 156 is located at a respective materials handling facility location 159. At least one courier 173 (FIG. 1) is associated with each materials handling facility 156 and may service a given service area 166 or route 176. Couriers 173 may also be assigned to deliver packages containing one or more items 143 (FIG. 1) in any service area 166 on an as needed basis.

Further shown are geocode locations 151 (FIG. 1) that correspond to customer locations 149 (FIG. 1) to which deliveries are to be made or where other courier tasks are to be performed. Courier tasks such as a delivery of a given package containing one or more items 143 associated with a geocode location 151 may be assigned to one or more materials handling facilities 156 (FIG. 1). Further, such courier tasks may be assigned to a courier 173 who performs deliveries within a service area 166 and/or courier route 176 to be serviced by the courier 173.

It should be noted that the geographical areas 163 and the service areas 166 may take any shape and are likely to depend upon geography, government boundaries, or other features of a given area.

FIG. 2 illustrates examples of service areas 166 associated with respective materials handling facilities 156. A service area 166 indicates an area where a courier 173 is to make deliveries and perform other courier tasks. The service area 166 may vary in size based at least in part on the number of geocode locations 151 that a courier is capable of visiting in a predetermined period of time, a number of packages of items 143 to be delivered or picked up by the courier 173 in a predetermined period of time, a proximity of the geocode locations 151 to each other, a density of geocode locations 151, routing of the courier 173 and other factors. Alternatively, rather than specifying service areas 166, a plurality of routes 176 may be specified within a given geographical area 163. Such routes 176 may be permanent or they may vary based on calculations from day to day given the specific deliveries that are to be made. The routes 176 may be contained within a given service area 166, or they may span across two or more service areas 166 depending on the shipments to be delivered at a given time.

In an additional alternative, a merchant may choose to employ mobile materials handling facilities 156 that operate out of an appropriate delivery vehicle. Such mobile materials handling facilities 156 may be stocked with high velocity items 143 that are expected to be sold in various geographical areas 163 or service areas 166. Such mobile materials handling facilities 156 may be deployed for immediate delivery of orders for items 143 in a predefined geographical area 163 or service area 166. Orders for items 143 that are received through the electronic commerce application 126 may be forwarded to fulfillment agents operating the mobile materials handling facilities 156.

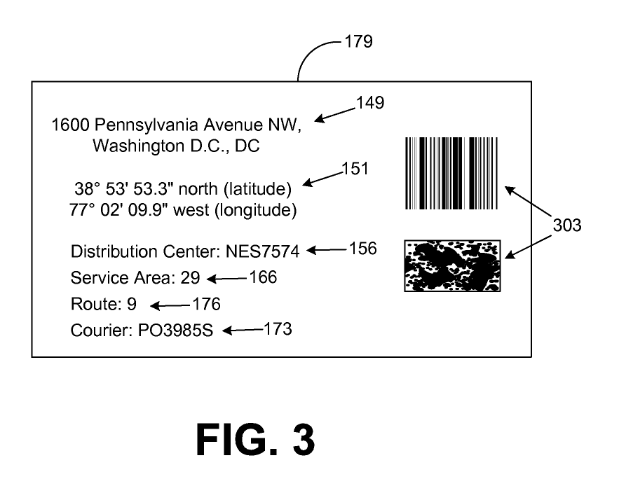

Turning to FIG. 3, shown is a drawing of an example of a shipping label 179 according to various embodiments of the present disclosure. The shipping label 179 illustrated includes an example of a customer location 149 which is a shipping address. The shipping label 179 further includes an example of a geocode location 151 including a latitude and a longitude and an identifier of a materials handling facility 156. In some embodiments, the shipping label 179 may further include a materials handling facility location 159 (FIG. 1) associated with the materials handling facility 156. In this example, the shipping label 179 further identifies a service area 166 where the geocode location 151 is situated where the items 143 in the shipment are to be delivered. In addition, the shipping label 179 also identifies both a route 176 in which the geocode location 151 is included and a courier 173 that is designated to deliver the shipment. The shipping label 179 also includes an example of a bar code 303. In some embodiments, information regarding the carrier infrastructure 153 (FIG. 1) including the customer location 149, the geocode location 151, the materials handling facility 156, the service area 166, the route 176, and the courier 173 may be encoded in one dimensional or two dimensional bar code 303. It should be noted that a lesser or greater number of components of the carrier infrastructure 153 may be included on the shipping label 179 depending on the level of detail that is known about a carrier infrastructure 153 that is invoked by the delivery of a given shipment. For example, it may be the case that routes 176 or the carriers 173 may not be known for a given shipment at the time the shipping label 179 is printed given that routes 176 and carrier assignments may change from day to day. In such case, such information may be excluded from the shipping label 179.

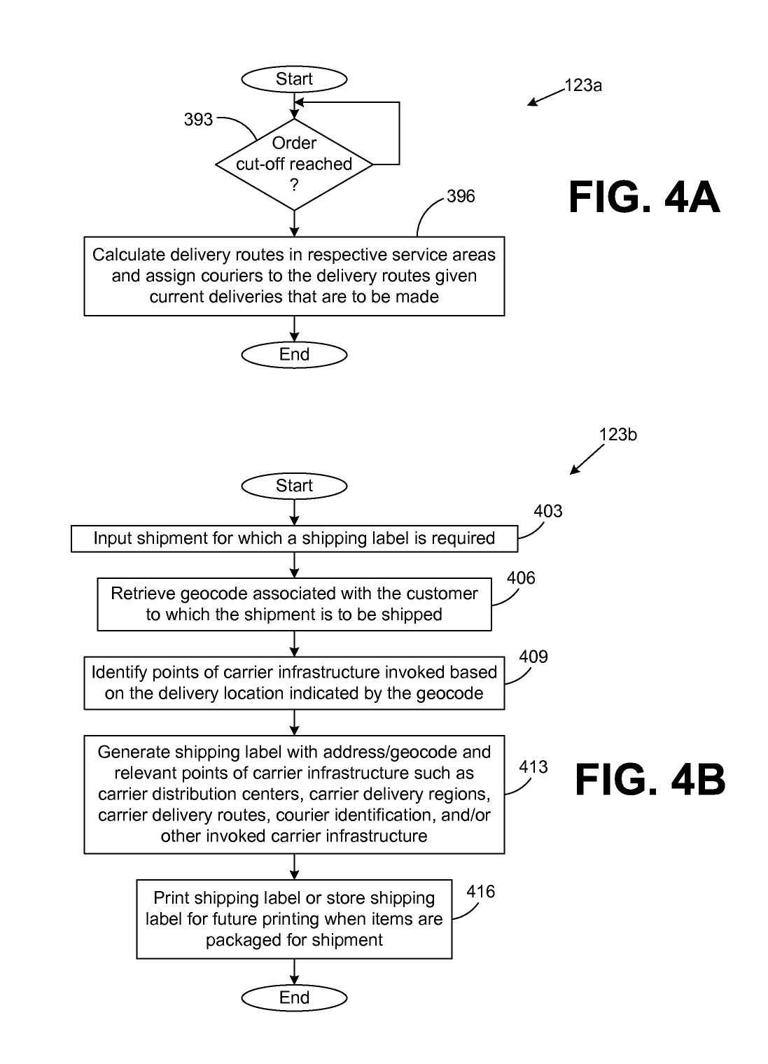

Referring next to FIGS. 4A and 4B, shown are flowcharts that provide examples of the operation of relevant portions of the carrier management application 123 (FIG. 1) according to various embodiments. It is understood that the flowcharts of FIGS. 4A and 4B provide merely examples of the many different types of functional arrangements that may be employed to implement the operation of the respective portions of the carrier management application 123 as described herein. As an alternative, the flowcharts of FIGS. 4A and 4B may be viewed as depicting examples of steps of methods implemented in the computing device 103 (FIG. 1) according to one or more embodiments.

The functionality of the courier management application described below assumes that a plurality of geocode locations 151 (FIG. 1) have been generated based at least in part on the customer locations 149 (FIG. 1). That is to say, each geocode location 151 corresponds to a respective customer location 149. Each geocode location 151 generated is associated with its corresponding customer location 149 in the data store 116 (FIG. 1). As discussed above in further detail, a geocode location 151 is expressed as a latitudinal value and a longitudinal value. A customer location 149 may be one of a shipping address associated with the customer 146 (FIG. 1), a location based at least in part on an Internet Protocol (IP) address associated with the customer 146, a current location of a client 106 such as a mobile computing device associated with the customer 146, and/or one of a variety of other locations associated with the customer 146.

In some embodiments, a geocode location 151 may be generated by a client 106 such as a mobile computing device associated with a courier 173 (FIG. 1) at a fixed location such as a residence or office of a customer 146. For example, the client 106 associated with the courier 173 may generate a geocode location 151 during a delivery of a package containing one or more items 143 to a customer 146 while the courier 173 is at the residence of the customer 146. Such a geocode location 151 is communicated to the carrier management application 123 in the computing device 103 that stores the same in association with a shipping address associated with the respective residence or office of the customer 146. In environments where a shipping address or zip code is not a reliable indicator of a fixed location, the geocode location 151 may be used by the carrier management application 123 as a more reliable indicator of the fixed location instead of a shipping address or zip code.

With specific reference to FIG. 4A, shown is an example of functionality in which the merchant is able to determine delivery routes for the shipment of packages containing items 143 due to the fact that the carrier infrastructure 153 is owned and operated by the merchant. That is to say, the merchant knows all of the deliveries that need to be made at a given time due to the fact that the merchant who sells items 143 through the electronic commerce application 126 (FIG. 1) acts as their own carrier. This may not be the case if the carrier was independent of the merchant and provides shipping services to other entities in addition to the merchant. According to one embodiment, shipments of items 143 may be made in waves or shifts in which orders for items 143 are coalesced together so that delivery routes 176 can be calculated for the delivery of such items 143 given that customer locations 149 and/or geocode locations 151 are known for such deliveries.

Turning then to FIG. 4A, in box 393, in a first portion, the carrier management application 123 determines whether an order cut-off window has been reached such that the current orders for items 143 received are to be shipped together in a wave or shift. When an order cut-off window is over, presumably no more orders are taken to be delivered in such a shift or wave. Orders for items 143 that are received after an order cut-off are presumably delivered in a subsequent shift or wave. Alternatively, it may be the case that orders received after an order cut-off window may be inserted into predefined delivery routes 176 if possible. Assuming the order cut-off has been reached, then the carrier management application 123 proceeds to box 396 to calculate delivery routes 176 in the respective service areas 166 for the delivery of the current shift or wave of shipments. Also, it may be possible that couriers 173 are assigned to respective delivery routes 176. In some cases, orders for items 143 may be received after the cut-off as mentioned above, where the deliveries for such items 143 are inserted into existing delivery routes 176 calculated as set forth above. In such case, the delivery of items 143 in the originally calculated delivery routes 176 will remain the same, where any shipping labels 179 that include at least a portion of the carrier infrastructure 153 for other shipments in the respective delivery route 176 remain valid. Thereafter, this portion of the carrier management application 123 ends as shown.

In cases where the carrier is an independent entity that services customers other than the merchant operating the electronic commerce application 126, the functionality of FIG. 4A may be omitted as the merchant will not have knowledge of all of the packages to be shipped by the carrier and it would not be possible to calculate delivery routes, etc. In some situations, a carrier may give a merchant the right to assign packages to carriers in exchange for some benefit. Further, a carrier may inform a merchant of all of the packages that the carrier is to deliver on a given day or other time period, including those from other customers of the carrier. The merchant may then calculate delivery routes for all of the packages to be delivered by the carrier. This may be a benefit where the merchant has superior technology to calculate delivery routes. Also, presumably the merchant would provide significant volume for the carrier relative to all of the customers of the carrier.

According to one embodiment, another example of functionality of the carrier management application 123 is described below with reference to FIG. 4B that is implemented each time a shipping label 179 (FIG. 3) is to be generated for a shipment of one or more items 143 (FIG. 1). This may be done, for example, when packing personnel place items 143 into appropriate packaging before being loaded onto delivery vehicles to be delivered to customers 146.

Beginning at box 403, the carrier management application 123 receives an input of an identifier associated with a shipment such as an order number or other identifier. Such an identifier may be input by an operator using a scanner, keyboard, or other input device as can be appreciated. In one embodiment, the operator may be packing the shipment in a fulfillment center, where the shipment is provided to a carrier for delivery to a customer 146.

Thereafter, in box 406, the carrier management application 123 retrieves the geocode location 151 associated with the customer to which the shipment is to be shipped. This is done because in some countries, it may be the case that the geocode location 151 is a much more reliable indication of where a shipment is to be delivered given inaccuracies in the address infrastructure of such countries.

Next, in box 409, the carrier management application 123 determines the points of the carrier infrastructure 153 that are invoked based on the geocode location 151. Specifically, portions of the carrier infrastructure 153 are invoked when they would be used or are otherwise involved in the delivery of a shipment of one or more items 143. Such portions of the carrier infrastructure 153 may comprise, for example, materials handling facilities 156, service areas 166, routes 176, couriers 173, and other aspects of a carrier infrastructure 153 as described above. In the case that delivery routes 176 have been precalculated, then the portions of the carrier infrastructure 153 that may be identified may include the delivery route 176 and the courier 173 that is to make the delivery of a package containing one or more items 143 as described above. Where the carrier is an independent entity, this level of information about the carrier infrastructure 153 may not be known unless it is provided by the carrier. In such case, the carrier would have to calculate delivery routes 176 based on deliveries to be made that were given to the carrier for such calculation provided that the carrier could make such calculations given that other entities may request the services of the carrier to deliver in the same areas.

Thereafter, in box 413, a shipping label is generated with the customer location 149, geocode location 151 and other portions or components of the carrier infrastructure identified in box 409 that were invoked by, or to be employed for, the delivery of the shipment of one or more items 143. Then, in box 416, the shipping label 179 is printed to be placed on the shipment, or the same is stored for future printing when items 143 are packaged for shipment. In one embodiment, the shipping label 179 may be forwarded in digital form to a carrier indicating that a certain mobile materials handling facility 156 is to be employed for a given delivery so that high velocity items 143 may be delivered immediately after being ordered through the electronic commerce application 126. Thereafter, this portion of the carrier management application 123 ends as shown.

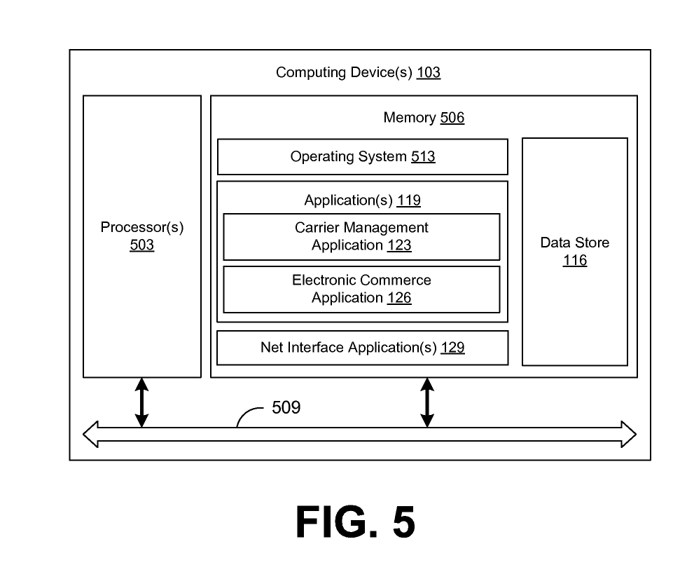

With reference to FIG. 5, shown is a schematic block diagram of the computing device 103 according to an embodiment of the present disclosure. The computing device 103 includes at least one processor circuit, for example, having a processor 503 and a memory 506, both of which are coupled to a local interface 509. To this end, the computing device 103 may comprise, for example, at least one server computer or like device. The local interface 509 may comprise, for example, a data bus with an accompanying address/control bus or other bus structure as can be appreciated.

Stored in the memory 506 are both data and several components that are executable by the processor 503. In particular, stored in the memory 506 and executable by the processor 503 are applications 119 such as the electronic commerce application 126, the carrier management application 123, and potentially other applications 119. Also stored in the memory 506 may be a data store 116 and other data. In addition, an operating system 513 may be stored in the memory 506 and executable by the processor 503.

It is understood that there may be other applications that are stored in the memory 506 and are executable by the processors 503 as can be appreciated. Where any component discussed herein is implemented in the form of software, any one of a number of programming languages may be employed such as, for example, C, C++, C#, Objective C, Java, Javascript, Perl, PHP, Visual Basic, Python, Ruby, Delphi, Flash, or other programming languages.

A number of software components are stored in the memory 506 and are executable by the processor 503. In this respect, the term “executable” means a program file that is in a form that can ultimately be run by the processor 503. Examples of executable programs may be, for example, a compiled program that can be translated into machine code in a format that can be loaded into a random access portion of the memory 506 and run by the processor 503, source code that may be expressed in proper format such as object code that is capable of being loaded into a random access portion of the memory 506 and executed by the processor 503, or source code that may be interpreted by another executable program to generate instructions in a random access portion of the memory 506 to be executed by the processor 503, etc. An executable program may be stored in any portion or component of the memory 506 including, for example, random access memory (RAM), read-only memory (ROM), hard drive, solid-state drive, USB flash drive, memory card, optical disc such as compact disc (CD) or digital versatile disc (DVD), floppy disk, magnetic tape, or other memory components.

The memory 506 is defined herein as including both volatile and nonvolatile memory and data storage components. Volatile components are those that do not retain data values upon loss of power. Nonvolatile components are those that retain data upon a loss of power. Thus, the memory 506 may comprise, for example, random access memory (RAM), read-only memory (ROM), hard disk drives, solid-state drives, USB flash drives, memory cards accessed via a memory card reader, floppy disks accessed via an associated floppy disk drive, optical discs accessed via an optical disc drive, magnetic tapes accessed via an appropriate tape drive, and/or other memory components, or a combination of any two or more of these memory components. In addition, the RAM may comprise, for example, static random access memory (SRAM), dynamic random access memory (DRAM), or magnetic random access memory (MRAM) and other such devices. The ROM may comprise, for example, a programmable read-only memory (PROM), an erasable programmable read-only memory (EPROM), an electrically erasable programmable read-only memory (EEPROM), or other like memory device.

Also, the processor 503 may represent multiple processors and the memory 506 may represent multiple memories that operate in parallel processing circuits, respectively. In such a case, the local interface 509 may be an appropriate network 109 (FIG. 1) that facilitates communication between any two of the multiple processors, between any processor and any of the memories, or between any two of the memories, etc. The local interface 509 may comprise additional systems designed to coordinate this communication, including, for example, performing load balancing. The processor 503 may be of electrical or of some other available construction.

Although the applications 119 including the carrier management application 123, the electronic commerce application 126, and other various systems described herein may be embodied in software or code executed by general purpose hardware as discussed above, as an alternative the same may also be embodied in dedicated hardware or a combination of software/general purpose hardware and dedicated hardware. If embodied in dedicated hardware, each can be implemented as a circuit or state machine that employs any one of or a combination of a number of technologies. These technologies may include, but are not limited to, discrete logic circuits having logic gates for implementing various logic functions upon an application of one or more data signals, application specific integrated circuits having appropriate logic gates, or other components, etc. Such technologies are generally well known by those skilled in the art and, consequently, are not described in detail herein.

The flowcharts of FIGS. 4A and 4B show the functionality and operation of an implementation of portions of the carrier management application 123. If embodied in software, each block may represent a module, segment, or portion of code that comprises program instructions to implement the specified logical function(s). The program instructions may be embodied in the form of source code that comprises human-readable statements written in a programming language or machine code that comprises numerical instructions recognizable by a suitable execution system such as a processor in a computer system or other system. The machine code may be converted from the source code, etc. If embodied in hardware, each block may represent a circuit or a number of interconnected circuits to implement the specified logical function(s).

Although the flowcharts of FIGS. 4A and 4B show a specific order of execution, it is understood that the order of execution may differ from that which is depicted. For example, the order of execution of two or more blocks may be scrambled relative to the order shown. Also, two or more blocks shown in succession in flowchart of FIGS. 4A and/or 4B may be executed concurrently or with partial concurrence. Further, in some embodiments, one or more of the blocks shown in flowchart of FIGS. 4A and/or 4B may be skipped or omitted. In addition, any number of counters, state variables, warning semaphores, or messages might be added to the logical flow described herein, for purposes of enhanced utility, accounting, performance measurement, or providing troubleshooting aids, etc. It is understood that all such variations are within the scope of the present disclosure.

Also, any logic or application described herein, including the carrier management application 123, that comprises software or code can be embodied in any non-transitory computer-readable medium for use by or in connection with an instruction execution system such as, for example, a processor in a computer system or other system. In this sense, the logic may comprise, for example, statements including instructions and declarations that can be fetched from the computer-readable medium and executed by the instruction execution system. In the context of the present disclosure, a “computer-readable medium” can be any medium that can contain, store, or maintain the logic or application described herein for use by or in connection with the instruction execution system. The computer-readable medium can comprise any one of many physical media such as, for example, magnetic, optical, or semiconductor media. More specific examples of a suitable computer-readable medium would include, but are not limited to, magnetic tapes, magnetic floppy diskettes, magnetic hard drives, memory cards, solid-state drives, USB flash drives, or optical discs. Also, the computer-readable medium may be a random access memory (RAM) including, for example, static random access memory (SRAM) and dynamic random access memory (DRAM), or magnetic random access memory (MRAM). In addition, the computer-readable medium may be a read-only memory (ROM), a programmable read-only memory (PROM), an erasable programmable read-only memory (EPROM), an electrically erasable programmable read-only memory (EEPROM), or other type of memory device.

It should be emphasized that the above-described embodiments of the present disclosure are merely possible examples of implementations set forth for a clear understanding of the principles of the disclosure. Many variations and modifications may be made to the above-described embodiment(s) without departing substantially from the spirit and principles of the disclosure. All such modifications and variations are intended to be included herein within the scope of this disclosure and protected by the following claims.

Therefore, the following is claimed:

1. A non-transitory computer-readable storage medium embodying a program executable in a computing device, comprising:
code that identifies at least a portion of a carrier infrastructure that is to be used to deliver each one of a plurality of shipments to a corresponding one of a plurality of destination locations, wherein the carrier infrastructure further comprises:
a plurality of geographical areas;
a plurality of materials handling facilities, each materials handling facility servicing at least one of the geographical areas; and
a plurality of delivery routes, wherein each of the delivery routes is calculated for the delivery of the shipments to the destination locations; and
code that generates a shipping label for each of the shipments, each shipping label expressing the one of the destination locations in terms of an address and a geocode location, and each shipping label expressing a recitation of the portion of the carrier infrastructure employed to deliver the respective shipment to aid a carrier in employing the carrier infrastructure to deliver each of the shipments.

2. The non-transitory computer-readable storage medium embodying the program executable in a computing device of claim 1, wherein the portion of the carrier infrastructure employed to deliver the respective shipment further includes a listing of one of the materials handling facilities.

3. The non-transitory computer-readable storage medium embodying the program executable in a computing device of claim 1, wherein the portion of the carrier infrastructure employed to deliver the respective shipment further includes a listing of one of the delivery routes.

4. A system, comprising:
at least one computing system;
an application executable in the at least one computing system, the application comprising:
logic that identifies one of a plurality of destination locations for delivery of a shipment to a recipient;
logic that identifies at least a portion of a carrier infrastructure that is to be used to deliver the shipment to the one of the destination locations; and
logic that generates a shipping label that expresses both the one of the destination locations and a recitation of the portion of the carrier infrastructure.

5. The system of claim 4, wherein each of the destination locations is expressed in the form of an address.

6. The system of claim 4, wherein each of the destination locations is expressed in the form of a geocode.

7. The system of claim 6, wherein at least one of the geocodes is obtained from a mobile device.

8. The system of claim 7, wherein the at least one of the geocodes is obtained from the mobile device contemporaneously with a delivery of an item by a courier carrying the mobile device.

9. The system of claim 4, wherein each of the destination locations is expressed as both a street address and a geocode, wherein each of the destination locations is associated with an account of a customer of an electronic commerce application.

10. The system of claim 4, wherein the carrier infrastructure further comprises at least one materials handling facility.

11. The system of claim 10, wherein the carrier infrastructure defines a geographical area serviced by the materials handling facility.

12. The system of claim 11, wherein logic that identifies the at least a portion of the carrier infrastructure that is to be used to deliver the shipment to the one of the destination locations further comprises logic that determines whether the materials handling facility is to be involved in the delivery of the shipment by determining whether the destination location falls within the geographical area.

13. The system of claim 4, wherein logic that identifies the at least a portion of the carrier infrastructure that is to be used to deliver the shipment to the one of the destination locations further comprises logic that determines whether the destination location falls within a service area defined as a portion of the carrier infrastructure.

14. The system of claim 4, wherein logic that identifies the at least a portion of the carrier infrastructure that is to be used to deliver the shipment to the one of the destination locations further comprises logic that identifies a delivery route in which the destination location may be included in order to deliver the shipment.

15. The system of claim 4, wherein logic that identifies the at least a portion of the carrier infrastructure that is to be used to deliver the shipment to the one of the destination locations further comprises logic that identifies a delivery courier who is to deliver the shipment to the recipient.

16. The system of claim 4, wherein the application further comprises logic that calculates a plurality of delivery routes for the delivery of a plurality of future shipments, where the future shipments include the shipment, wherein the carrier infrastructure includes the delivery routes.

17. The system of claim 16, wherein the application is further configured to assign a courier to each one of the delivery routes.

18. A method, comprising the steps of:
identifying, in at least one computing device, at least a portion of a carrier infrastructure that is to be used to deliver each one of a plurality of shipments, each of the shipments corresponding to one of a plurality of destination locations; and
generating, in the at least one computing device, a shipping label for each of the shipments, wherein each shipping label expresses both a respective one of the destination locations and a recitation of the portion of the carrier infrastructure employed to deliver a corresponding one of the shipments to a respective one of the destination locations.

19. The method of claim 18, further comprising the step of calculating in the at least one computing device a plurality of delivery routes for the delivery of the shipments to the destination locations, each of the delivery routes being included in the carrier infrastructure.

20. The method of claim 18, further comprising the step of storing a plurality of geocode locations in association with a plurality of customers in a memory associated with the at least one computing device, wherein the destination locations further comprise the geocode locations.

21. The method of claim 18, further comprising the step of storing a plurality of addresses in association with a plurality of customers in a memory associated with the computing device, wherein the destination locations further comprise the addresses.

22. The method of claim 18, wherein the step of identifying, in the at least one computing device, the at least a portion of the carrier infrastructure that is to be used to deliver each one of the shipments, where each of the shipments correspond to one of the destination locations, further comprises the step of determining the portion of the carrier infrastructure that is needed to deliver each of the shipments to a respective one of the destination locations.
